(19) United States
(12) Patent Application Publication
(10) Pub. No.: US 2025/0086778 A1
(43) Pub. Date: Mar. 13, 2025

(54) INTELLIGENT SYSTEM AND METHOD FOR DETECTING FILAMENT BREAKAGE AND NEEDLE BREAKAGE

(71) Applicant: HANGZHOU DIANZI UNIVERSITY, Hangzhou (CN)

(72) Inventors: Yuanfang CHEN, Hangzhou (CN); Jian WANG, Hangzhou (CN); Guoqiang JIN, Hangzhou (CN); Shengyuan XIAO, Hangzhou (CN); Liwei LIU, Hangzhou (CN); Shijie ZHU, Hangzhou (CN); Xiaoan SUN, Hangzhou (CN); Jun NI, Hangzhou (CN); Chen QIAN, Hangzhou (CN); Kan ZHENG, Hangzhou (CN); Zhaoji HU, Hangzhou (CN); Xuanxing DU, Hangzhou (CN); Hangbin CHEN, Hangzhou (CN)

(21) Appl. No.: 18/885,697

(22) Filed: Sep. 15, 2024

(51) Int. Cl. G06T 7/00; D04B 35/14; D04B 35/18; G06T 7/13; G06V 10/764; G06V 10/774; G06V 10/776

(52) U.S. Cl. CPC G06T 7/0004; D04B 35/14; D04B 35/18; G06T 7/13; G06V 10/764; G06V 10/774; G06V 10/776; G06T 2207/20021; G06T 2207/20081; G06T 2207/20084; G06T 2207/30124; G06T 2207/30168

(57) ABSTRACT

A system for detecting filament and needle breakage, including: an image acquisition module, an image processing module and a host computer detection module. The image acquisition module includes a light source, a camera and a lens. The image processing module includes a preprocessing submodule and a detection model. The host computer detection module includes a shutdown control-data interaction submodule of a warp knitting machine, a sensor control board, and a system operation interface. The image acquisition module captures a blanket knitting image at a knitting mechanism of the warp knitting machine. The image processing module pre-processes the blanket knitting image and detects filament and needle breakage. The host computer detection module controls a textile device according to detection results to generate an alarming information. A detection method implemented by the system is further provided.

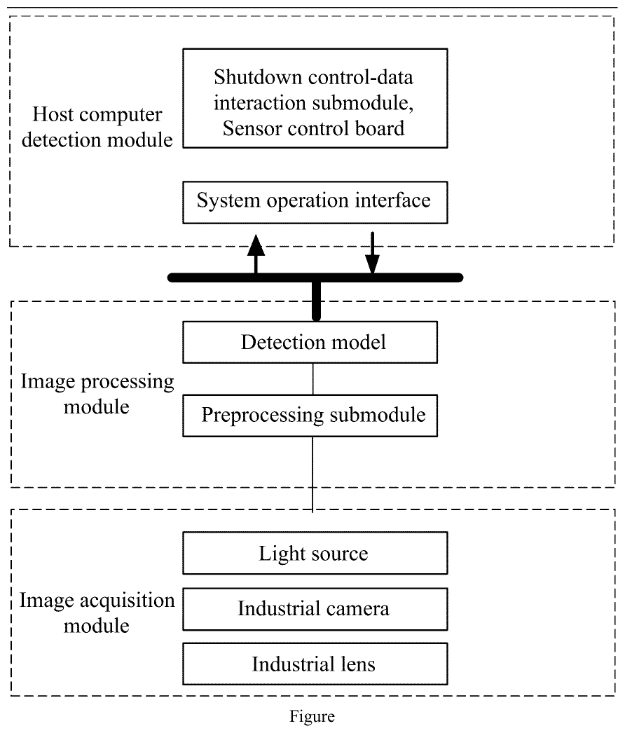

### TECHNICAL FIELD

This application relates to computer vision technology, and more particularly to an intelligent system and method for detecting filament breakage and needle breakage.

### BACKGROUND

Textile industry, which is the pillar industry of national economy and important livelihood industry in China, is facing various challenges in the critical period of transformation and upgrading. A series of strategies, such as deep integration of the informatization and industrialization, acceleration of the transformation of old and new kinetic energy and intelligent manufacturing, have been proposed to promote the high-end and high-profit development of the textile industry. In the textile production process (e.g., blanket), the raw material “silk thread”, is fragile, and thus how to avoid the blanket defects caused by thread breakage has been a key to improve the blanket quality.

Currently, the filament breakage is still mostly monitored by manual operation. The high-frequency shaking operation state of the textile device will make the manual detection have low accuracy and high missing rate, which will directly affect the quality of finished products, and result in poor cost-effectiveness. In addition, due to the technological limitations, a post-hoc defect detection method is often used in the practical application, that is, detecting the grey cloth produced by looms. However, this method has poor versatility and high cost, and cannot essentially reduce the raw material loss and improve the production efficiency.

In recent years, with the rapid development of textile technology, the traditional manual detection and post-hoc defect detection methods cannot meet the actual production needs any more, and considerable attempts have been made to introduce the computer vision to the filament breakage detection.

### SUMMARY

In view of the deficiencies in the prior art, this application provides an intelligent system and method for detecting filament breakage and needle breakage, which can achieve the real-time, on-line and precise (detection precision higher than 90%, and missing rate lower than 1%) detection of defects caused by filament breakage during the blanket production process, thereby facilitating the cost reduction, improvement of efficiency, yield rate and stability of product quality, and reduction of material consumption.

Technical solutions of this application are described as follows.

This application provides a system for detecting filament breakage and needle breakage, comprising:
an image acquisition module;
an image processing module; and
a host computer detection module;
wherein the image acquisition module comprises a light source, a camera and a lens; the image processing module comprises a preprocessing submodule and a detection model; and the host computer detection module comprises a shutdown control-data interaction submodule of a warp knitting machine, a sensor control board and a system operation interface; and
the image acquisition module is configured to capture a blanket knitting image at a knitting mechanism of the warp knitting machine; the preprocessing submodule is configured to pre-process the blanket knitting image, and the detection model is configured to perform filament breakage and needle breakage detection on the blanket knitting image; and the host computer detection module is configured to control a textile device and generate an alarming information according to results of the filament breakage and needle breakage detection.

In an embodiment, the detection model is based on a Transformer model, and is configured to divide the blanket knitting image into a plurality of patches based on a Transformer model, convert the plurality of patches into sequence data, and process the sequence data by using components of the Transformer model;

the components of the Transformer model comprise a patch embedding layer, a positional embedding layer, a Transformer encoder, a normalization layer, and a classification head;

the patch embedding layer is configured to divide the blanket knitting image into the plurality of patches, and convert each of the plurality of patches into a vector representation with a fixed length by a linear projection operation;

the positional embedding layer is configured to add positional information to the vector representation so that the detection model is capable of capturing relative positional relationships between the plurality of patches;

the Transformer encoder comprises a plurality of encoder layers; each of the plurality of encoder layers comprises a multi-head self-attention layer and a feed-forward neural network; the multi-head self-attention layer is configured to establish an attention relationship between elements in the sequence data; and the feed-forward neural network is configured to perform non-linear transformation on each of the elements in the sequence data by using a multi-layer perceptron;

the normalization layer is configured to normalize an output of each of the plurality of encoder layers to control a gradient flow and accelerate a training process; and

the classification head is a final layer of the Transformer model, and is configured to map an output of a final encoder layer among the plurality of encoder layers to a probability distribution of defect categories.

This application further provides a method for detecting filament breakage and needle breakage by using the system above, comprising:
(S1) fixing a plurality of cameras; setting Region of Interest (ROI) and exposure time for each of the plurality of cameras; and capturing, by the plurality of cameras, the blanket knitting image at a crochet needle of the knitting mechanism in real time under irradiation of the light source;
(S2) performing, by the detection model, the filament breakage and needle breakage detection in real time on the blanket knitting image to obtain detection results;
(S3) sending the detection results obtained in step (S2) to the host computer detection system via serial communication; and displaying the detection results in the system operation interface; and
(S4) judging whether there is a defect in a blanket according to the detection results; if yes, outputting, by a microcontroller in the host computer detection module, a binary signal to a switching circuit of the warp knitting machine to stop the warp knitting machine, determining a type and location of the defect, and warning an operator to repair a broken filament or change a needle according to the type and location of the defect; otherwise, returning to step (S2) to continuously monitor operation condition of the warp knitting machine.

In an embodiment, step (S1) comprises:
(a1) collecting a data sample set involving various types of filament breakages in the blanket for labelling inner and outer broken filament characteristics;
(a2) generating, by a generative adversarial network, a plurality of virtual images with a boundary defect feature to expand the data sample set and provide more training data; and
(a3) extracting edge information from an image set comprising the plurality of virtual images and the blanket knitting image by using a Laplacian operator; calculating an edge change rate based on the edge information to evaluate a blur degree of the image set; and removing an image with the blur degree exceeding a pre-set threshold from the image set.

In an embodiment, in step (S2), the detection model is trained through steps of:
(b1) data preparation: preparing a dataset required for a blanket defect detection task, wherein the dataset comprises labelled image samples comprising a defective image and a non-defective image, labels respectively corresponding to the defective image and the non-defective image, and bounding box information of the defective image;
(b2) model construction: constructing the detection model based on a Transformer model;
(b3) image pre-processing: dividing, by the detection model, the blanket knitting image into a plurality of patches with a fixed size; normalizing a pixel value of each of the plurality of patches to a preset range; and performing data augmentation on the dataset to increase diversity of the labelled image samples;
(b4) loss function definition: selecting a binary cross-entropy loss function as a loss function for the blanket defect detection task;
(b5) model training: based on the dataset and the loss function, training the detection model by using a backpropagation algorithm through steps of:
inputting the plurality of patches into the detection model to obtain an output; comparing the output with the labels to calculate a loss; and updating parameters of the detection model based on the loss to optimize performance of the detection model;
(b6) model evaluation: evaluating a trained detection model using an independent test set; and calculating an accurate rate, a precision ratio, and a missing rate to evaluate performance of the trained detection model in terms of the blanket defect detection task;
(b7) hyperparameter adjustment: adjusting hyperparameters of the trained detection model according to actual requirements and performance evaluation results to improve the performance of the trained detection model; wherein the hyperparameters comprise a learning rate, a batch size, and the number of training iterations; and
(b8) prediction and application: performing defect detection by using the trained detection model through steps of:
dividing a new image into a plurality of new patches; and predicting classification results or defect location information of each of the plurality of new patches by the trained detection model, so as to complete the defect detection.

Compared to the prior art, this application has the following beneficial effects.

1. This application obtains a clear image first by preprocessing to improve the model accuracy and reduce the missing rate of the filament breakage detection of the blanket.

2. This application adopts the detection and recognition algorithm based on Transformer framework and realizes real-time and high-precision recognition of the broken position of the blanket, thereby achieving detection precision higher than 90%, and missing rate lower than 1%. The performance of the system provided in this application is far more than the existing similar systems, and effectively complete the cost reduction and high efficiency of the enterprises.

3. This application provides a complete intelligent detection system including software and hardware. Based on efficiently obtaining the image of the blanket, the system provided in this application quickly detects the broken filaments through image processing and detection algorithms and provides powerful technical support for the production improvement of the textile industry.

### BRIEF DESCRIPTION OF THE DRAWINGS

The FIGURE is a block diagram of a system for detecting filament breakage and needle breakage according to an embodiment of the present disclosure.

### DETAILED DESCRIPTION OF EMBODIMENTS

The disclosure will be further described in detail below with reference to the embodiments and accompanying drawings to facilitate the understanding of the technical solutions of the disclosure. Obviously, described below are merely some embodiments of the disclosure, which are not intended to limit the disclosure. For those skilled in the art, other embodiments obtained based on these embodiments without paying creative efforts should fall within the scope of the disclosure defined by the appended claims.

As shown in the FIGURE, a system for detecting filament breakage and needle breakage provided herein includes an image acquisition module, an image processing module, and a host computer detection module.

The image acquisition module includes a light source, an industrial camera and an industrial lens. The image processing module includes a preprocessing submodule and a detection model. The host computer detection module includes a shutdown control-data interaction submodule of a warp knitting machine, a sensor control board and a system operation interface.

Firstly, the image acquisition module captures blanket knitting images at a knitting mechanism of the warp knitting machine. Then, the image preprocessing submodule pre-processes the blanket knitting images, and the detection model performs filament breakage and needle breakage detection on the blanket knitting images. Finally, the host computer detection module controls the textile device and generates the alarming information according to the results of the filament breakage and needle breakage detection.

In an embodiment, the detection model is based on the Transformer model and configured to divide the blanket knitting image into a plurality of patches, convert the plurality of patches into sequence data, and processes these sequence data by using various components of Transformer model.

The components of the Transformer model include a patch embedding layer, a positional embedding layer, a Transformer encoder, a normalization layer, and a classification head.

The patch embedding layer is configured to divide the blanket knitting image into the plurality of patches, and convert each of the plurality of patches into a vector representation with a fixed length by a linear projection operation.

The positional embedding layer is configured to add positional information to the vector representation so that the detection model is capable of capturing relative positional relationships between the plurality of patches.

The Transformer encoder includes a plurality of encoder layers. Each of the plurality of encoder layers includes a multi-head self-attention layer and a feed-forward neural network. The multi-head self-attention layer establishes an attention relationship between the elements in the sequence data. The feed-forward neural network is configured to perform non-linear transformation on each of the elements in the sequence data by using a multi-layer perceptron.

The normalization layer is configured to normalize an output of each of the plurality of encoder layers to better control a gradient flow and accelerate a training process.

The classification head is a final layer of the Transformer model and is configured to map the output of a final encoder layer among the plurality of encoder layers to a probability distribution of defect categories.

An intelligent detection method of filament breakage and needle breakage by using the system described above, includes the following steps (S1) -(S4).

(S1) A plurality of industrial cameras are fixed, and the camera configuration is completed. The Region of Interest (ROI) and the exposure time for each of the plurality of cameras are set. Under the irradiation of the industrial light source, the blanket knitting images at the crochet needle of the knitting mechanism are captured in real time.

(S2) The detection model performs the filament breakage and needle breakage detection in real time on the blanket knitting image to obtain the detection results, such as the type and the location of the defect.

(S3) The detection results obtained in step (S2) are sent to the host computer detection system via serial communication. The detection results are displayed in the system operation interface.

(S4) Whether there is a defect in the blanket is determined according to the detection results, if yes, a microcontroller in the host computer detection module outputs a binary signal to a switching circuit of the warp knitting machine to stop the warp knitting machine, determine a type and location of the defect, and warn an operator to repair the broken filament or change a needle according to the type and location of the defect; otherwise, return to step (S2) to continuously monitor operation condition of the warp knitting machine.

In an embodiment, step (S1) includes steps (S1-1) -(S1-3).

(S1-1) A data sample set involving various types of filament breakages in the blanket is collected for labelling inner and outer broken filament characteristics.

(S1-2) In order to further increase the diversity and richness of the data sample set, the generative adversarial network is used for generating a plurality of virtual images with boundary defect features, which have certain defect features but are relatively weak, and can expand the sample set and provide more training data.

(S1-3) Edge information is extracted from an image set including the plurality of virtual images and the blanket knitting image by using a Laplacian operator. An edge change rate is calculated based on the edge information to evaluate a blur degree of the image set. An image with the blur degree exceeding a pre-set threshold is removed from the image set.

In an embodiment, in step (S2), the detection model is trained through the following steps (S2-1)-(S2-8).

### (S2-1) Data Preparation

A dataset required for a blanket defect detection task is prepared. The dataset includes labelled image samples comprising a defective image and a non-defective image, labels respectively corresponding to the defective image and the non-defective image, and bounding box information of the defective image.

### (S2-2) Model Construction

The detection model is constructed based on a Transformer model.

### (S2-3) Image Pre-Processing

The detection model divides the blanket knitting image into the plurality of patches with the fixed size. The pixel value of each of the plurality of patches is normalized to a preset range, and the data augmentation is performed on the dataset to increase diversity of the labelled image samples.

### (S2-4) Loss Function Definition

The binary cross-entropy loss function is chosen as the loss function for the defect detection task.

### (S2-5) Model Training

Based on the prepared dataset and the defined loss function, the detection model is trained by using the backpropagation (BP) algorithm. During the training process, the plurality of patches are input into the detection model to obtain an output, the output is compared with the labels to calculate a loss. Parameters of the detection model are updated based on the loss to optimize performance of the detection model.

### (S2-6) Model Evaluation

The trained detection model is evaluated using an independent test set, and an accurate rate, a precision ratio, and a missing rate are calculated to evaluate performance of the trained detection model in terms of the blanket defect detection task.

### (S2-7) Hyperparameter Adjustment

Hyperparameters of the trained detection model are adjusted according to actual requirements and performance evaluation results to improve performance of the trained detection model, where the hyper-parameters include a learning rate, a batch size, and the number of training iterations.

### (S2-8) Prediction and Application

The defect detection is performed by using the trained detection model through steps of dividing a new image into a plurality of new patches, and predicting classification results or defect location information of each of the plurality of new patches by the trained detection model, so as to complete the defect detection.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A system for detecting filament breakage and needle breakage, comprising:
an image acquisition module;
an image processing module; and
a host computer detection module;
wherein the image acquisition module comprises a light source, a camera and a lens; the image processing module comprises a preprocessing submodule and a detection model; and the host computer detection module comprises a shutdown control-data interaction submodule of a warp knitting machine, a sensor control board and a system operation interface; and
the image acquisition module is configured to capture a blanket knitting image at a knitting mechanism of the warp knitting machine; the preprocessing submodule is configured to pre-process the blanket knitting image, and the detection model is configured to perform filament breakage and needle breakage detection on the blanket knitting image; and the host computer detection module is configured to control a textile device and generate an alarming information according to results of the filament breakage and needle breakage detection.

2. The system of claim 1, wherein the detection model is based on a Transformer model, and is configured to divide the blanket knitting image into a plurality of patches, convert the plurality of patches into sequence data, and process the sequence data by using components of the Transformer model;
the components of the Transformer model comprise a patch embedding layer, a positional embedding layer, a Transformer encoder, a normalization layer, and a classification head;
the patch embedding layer is configured to divide the blanket knitting image into the plurality of patches, and convert each of the plurality of patches into a vector representation with a fixed length by a linear projection operation;
the positional embedding layer is configured to add positional information to the vector representation so that the detection model is capable of capturing relative positional relationships between the plurality of patches;
the Transformer encoder comprises a plurality of encoder layers; each of the plurality of encoder layers comprises a multi-head self-attention layer and a feed-forward neural network; the multi-head self-attention layer is configured to establish an attention relationship between elements in the sequence data; and the feed-forward neural network is configured to perform non-linear transformation on each of the elements in the sequence data by using a multi-layer perceptron;
the normalization layer is configured to normalize an output of each of the plurality of encoder layers to control a gradient flow and accelerate a training process; and
the classification head is a final layer of the Transformer model, and is configured to map an output of a final encoder layer among the plurality of encoder layers to a probability distribution of defect categories.

3. A method for detecting filament breakage and needle breakage by using the system of claim 1, comprising:
(S1) fixing a plurality of cameras; setting Region of Interest (ROI) and exposure time for each of the plurality of cameras; and capturing, by the plurality of cameras, the blanket knitting image at a crochet needle of the knitting mechanism in real time under irradiation of the light source;
(S2) performing, by the detection model, the filament breakage and needle breakage detection in real time on the blanket knitting image to obtain detection results;
(S3) sending the detection results obtained in step (S2) to the host computer detection system via serial communication; and displaying the detection results in the system operation interface; and
(S4) judging whether there is a defect in a blanket according to the detection results; if yes, outputting, by a microcontroller in the host computer detection module, a binary signal to a switching circuit of the warp knitting machine to stop the warp knitting machine, determining a type and location of the defect, and warning an operator to repair a broken filament or change a needle according to the type and location of the defect; otherwise, returning to step (S2) to continuously monitor operation condition of the warp knitting machine.

4. The method of claim 3, wherein step (S1) comprises:
(a1) collecting a data sample set involving various types of filament breakages in the blanket for labelling inner and outer broken filament characteristics;
(a2) generating, by a generative adversarial network, a plurality of virtual images with a boundary defect feature to expand the data sample set and provide more training data; and
(a3) extracting edge information from an image set comprising the plurality of virtual images and the blanket knitting image by using a Laplacian operator; calculating an edge change rate based on the edge information to evaluate a blur degree of the image set; and removing an image with the blur degree exceeding a pre-set threshold from the image set.

5. The method of claim 3, wherein in step (S2), the detection model is trained through steps of:
(b1) preparing a dataset required for a blanket defect detection task, wherein the dataset comprises labelled image samples comprising a defective image and a non-defective image, labels respectively corresponding to the defective image and the non-defective image, and bounding box information of the defective image;
(b2) constructing the detection model based on a Transformer model;
(b3) dividing, by the detection model, the blanket knitting image into a plurality of patches with a fixed size; normalizing a pixel value of each of the plurality of patches to a preset range; and performing data augmentation on the dataset to increase diversity of the labelled image samples;
(b4) selecting a binary cross-entropy loss function as a loss function for the blanket defect detection task;
(b5) based on the dataset and the loss function, training the detection model by using a backpropagation algorithm through steps of:
inputting the plurality of patches into the detection model to obtain an output; comparing the output with the labels to calculate a loss; and updating parameters of the detection model based on the loss to optimize performance of the detection model;
(b6) evaluating a trained detection model using an independent test set; and calculating an accurate rate, a precision ratio, and a missing rate to evaluate performance of the trained detection model in terms of the blanket defect detection task;
(b7) adjusting hyperparameters of the trained detection model according to actual requirements and performance evaluation results to improve the performance of the trained detection model; wherein the hyperparameters comprise a learning rate, a batch size, and the number of training iterations; and
(b8) performing defect detection by using the trained detection model through steps of:
dividing a new image into a plurality of new patches; and predicting classification results or defect location information of each of the plurality of new patches by the trained detection model, so as to complete the defect detection.
